(19) United States
(12) Patent Application Publication
(10) Pub. No.: US 2021/0362971 A1
(43) Pub. Date: Nov. 25, 2021

(54) ADVANCING A BELT TOWARD A PRINTING STATION

(71) Applicant: Hewlett-Packard Development Company, L.P., Spring, TX (US)

(72) Inventors: Ricardo SANCHIS ESTRUCH, Sant Cugat de Valles (ES); Javier ONECHA CELLESTINO, Sant Cugat de Valles (ES); Eduardo MARTIN ORUE, Sant Cugat de Valles (ES); Daniel GONZALEZ PERELLO, Sant Cugat de Valles (ES); Joaquim BRUGUE GARVI, Sant Cugat de Valles (ES); Kurt VANDENBERGH, Lommel (ES)

(73) Assignee: Hewlett-Packard Development Company, L.P., Spring, TX (US)

(21) Appl. No.: 17/050,389

(22) PCT Filed: Aug. 8, 2018
(86) PCT No.: PCT/US2018/045696

§ 371 Date: Oct. 23, 2020

(51) Int. Cl. B65H 5/02; B65G 15/64; B65G 15/42

(52) U.S. Cl. CPC B65H 5/025; B65H 2404/25; B65G 15/42; B65G 15/64

(57) ABSTRACT

In one example, a conveyance module to advance a belt toward a print station comprises a support structure to support a belt and to permit advance of the belt in a belt-advance direction toward a print station and a pair of guides. In this example, each guide is attached to the support structure and is to engage a portion of a belt. A first guide in the pair is attached to the support structure by a substantially rigid fastener to hold the first guide in a substantially fixed position relative to the support structure. A second guide in the pair is attached to the support structure by a resiliently deformable element to hold the second guide in a movable position relative to the support structure.

### BACKGROUND

Print apparatuses, for example print apparatuses with multiple print zones, are subject to registration errors.

### BRIEF DESCRIPTION OF DRAWINGS

Examples will now be described, by way of non-limiting example, with reference to the accompanying drawings, in which:

FIG. 1 shows an example conveyance module;

FIG. 2 shows an example conveyance module;

FIG. 3 shows an example print apparatus;

FIG. 4 is a flowchart of an example method; and

FIG. 5 is a flowchart of an example method.

### DETAILED DESCRIPTION

In some print apparatuses, a substrate (e.g. a sheet) may be advanced through a plurality of print zones, for example a plurality of areas, each area having a print bar to deposit a printing fluid (such as an ink) onto the substrate. For example, in a multi-print bar system or scanning multipass system, a substrate may be advanced through a plurality of stations at which a printing fluid (e.g. an ink) may be deposited onto the substrate. The substrate, in some examples, may be supported by a belt, for example held against the belt by a vacuum. In such examples, the belt may advance the substrate through a plurality of print zones to apply printing fluid to the substrate. Such example print apparatuses may be subject to registration errors. For example, a registration error may occur in the belt-advance direction (the direction of belt, and therefore substrate, movement), sometimes referred to as “downweb” error; and in the direction perpendicular to the belt-advance direction, sometimes referred to as “crossweb” error.

In some example print apparatuses, crossweb error may be difficult to predict, control, and/or correct. In a multiple print zone print apparatus where a substrate is advanced toward and through a plurality of print stations, and where, at each print station, printing fluid from a printing fluid dispensing unit may be deposited on a substrate, crossweb error may result in a reduced image quality. For example, crossweb error may result in snake effects, vertical banding, dark/light contrasts in the same areas etc.

For example, in a print apparatus in which a substrate moves continuously through several printing zones, the printing zones may be separated from one another, for example separated from one another in the belt-advance direction, e.g. by several centimetres or even more than one metre. The separation distance between printing zones may result in crossweb error due to previously printed dots being placed in an unexpected, or moved, position in the following print zone (e.g. printed dots being out of alignment with their corresponding positon in the previous print zone) due to factors such as traction in the print apparatus shifting the substrate between print zones. To minimize the crossweb error in a printing process, a subsequent printing fluid deposit (i.e. deposited at a subsequent print zone) should fall either as close as possible to the previous printing fluid deposit (i.e. printing fluid deposited at a previous print zone) or the subsequent deposit should be positioned a well-controlled, or well-defined, distance from the previous printing fluid deposit. If, e.g. due to crossweb error, this does not occur then there may be a corresponding decline in the resulting image quality.

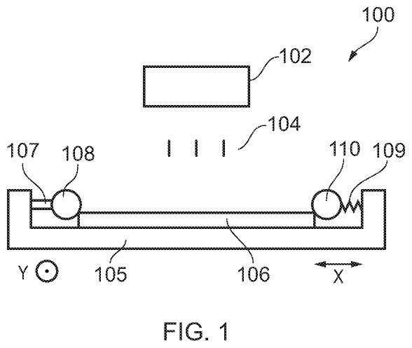

FIG. 1 shows a conveyance module 100. The conveyance module 100 may be part of a print apparatus, for example a print apparatus comprising a plurality of print stations. For example, the conveyance module 100 may be part of a continuous print process (e.g. a print apparatus comprising a sheet path on which the sheet may move continuously through a plurality of print stations, the sheet being advanced by the conveyance module, e.g. on a belt advanced by the conveyance module).

The conveyance module 100 comprises a support structure 105. The support structure 105 is to support a belt 106 and to permit advance of the belt 106 in a belt-advance direction Y toward a print bar (schematically indicated by 102). In this example, the print bar 102 is to deliver printing fluid (schematically indicated by droplets 104) onto the belt 106. In this example, the support structure 105 is to advance the belt 106 in the belt-advance direction Y toward the print bar 102 so that printing fluid may be delivered by the print bar 102 onto the belt 106 (or, in one example, onto a substrate being supported on the belt 106, e.g. held to the belt 106 via vacuum).The conveyance module 100 comprises a pair of guides 108, 110. Each guide 108, 110 is attached to the support structure 105 and is to engage a portion of the belt 106.

A first guide 108 is attached to the support structure 105 by a substantially rigid fastener 107 and is held in a substantially fixed position relative to the support structure 105. A second guide 110 is attached to the support structure 105 by a resiliently deformable element 109 and is held in a movable position relative to the support structure 105. The substantially rigid fastener 107 of this example may hold the first guide 108 in the substantially fixed position relative to the support structure 105 and the resiliently deformable element 109 of this example may hold the second guide 110 in the movable position relative to the support structure 105.

For example, the second guide 110 may be movable in the direction X. For example, the second guide 110 may be movable toward, and away from, the belt 106. In one example, the belt 106 is movable along a belt-advance direction, which in the example of FIG. 1 may be the direction Y, and the second guide 110 is movable in a direction X, the direction X being perpendicular to the direction Y. In other words, the second guide 110 may be in a movable position, and may be movable in a direction perpendicular to the belt-advance direction. The second guide 110 may therefore be movable to engage at least a portion of the belt 106. In other words, the resiliently deformable element 109 may be to movably bias the second guide 110 into engagement with the belt, e.g. to movably bias the second guide 110 in the direction X. The first and second guides 108, 110 may each be to engage the belt 106 as the belt 106 moves in the belt-advance direction Y. The second guide 110 may be biased, e.g. the resiliently deformable element 109 may be to bias the second guide 110, in a direction opposite to the first guide 108.

The conveyance module 100 in this example may therefore more precisely guide the belt in the crossweb direction, e.g. as the belt advances toward a print bar, or a printing apparatus comprising a print bar. For example, the belt may advance a sheet supported thereon (e.g. a sheet may be engaged to the belt via a vacuum) toward and/or through the print bar 102 at which printing fluid may be deposited onto the sheet. The pair of guides 108, 110 may engage the belt as the belt advances toward and/or underneath the print bar 102 to fix the belt's position relative to the print bar 102 during a print job. This may reduce crossweb error since, at each print bar, an alignment operation may be performed via engagement between the belt 106 and the two guides 108, 110 of the print station 100. At each print station, engagement between the belt 106 and the guides 108, 110 may align the belt 106 in the crossweb direction (e.g. fix the belt in the crossweb direction). The crossweb direction, in this example, may be the direction perpendicular to the belt-advance direction, e.g. perpendicular to the direction Y. The cross-web direction may be parallel to the direction X. Hence, in one example, the second guide 110 may be movable in the crossweb direction. For example, the resiliently deformable element 109 may be to movably bias the second guide 110 into engagement with the belt, e.g. to movably bias the second guide 110 in the crossweb direction.

The first guide 108 in this example is held in a substantially fixed position relative to the support structure 105 by the substantially rigid fastener 107. The first guide 108 may therefore be a ‘fixed’ guide in that its position relative to the support structure 105 may be fixed during engagement between the first guide 108 and the belt 106. In one example, the second guide 110, held in a movable position relative to the print station 100, may be to maintain the belt in the crossweb direction during printing, and/or maintain the belt under transversal tension, and/or may reduce instances of the belt being pulled to one side.

In one example, the substantially rigid fastener may be attached to the support structure 105 via a removable fastening mechanism, e.g. a bolt or screw, to enable the first guide 108 to be repositioned on the support structure. In one example, the resiliently deformable fastener may be attached to the support structure 105 via a removable fastening mechanism, e.g. a bolt or screw, to enable the second guide 110 to be repositioned on the support structure. In one example, the resiliently deformable element 109 may comprise an elastic element. In one example, the resiliently deformable element may comprise a spring. In this example, the spring constant of the spring may be selected to facilitate contact with the belt 106 but to avoid large friction forces. In one example, the spring constant may be selected to be equal to, or approximately equal to, 3 N/mm.

Each guide 108, 110 may engage a portion of the belt 106 prior to that portion of the belt 106 advancing past, via, or under, a print bar 102. There may therefore, in one example, be contact between a belt 106 advancing a sheet and one of the guides 108, 110 just before a printing zone (the printing zone in this example being the area under the print bar 102). As the first guide 108 is in a substantially fixed position relative to the support structure 105, as the first guide 108 engages the belt 106 (e.g. one side of the belt 106), the part of the belt 106 that engages the first, fixed, guide 108 may define the belt's movement.

The second guide 110, which is in a movable position relative to the support structure 105 as, in this example, the second guide 110 is attached to the support structure 105 by the resiliently deformable element 109, may move as it is engaged with a portion of the belt 106 as the belt 106 advances toward and/or through the print station 100. For example, as the second guide 110 is engaged with a portion of the belt 106, the second guide 110 may move in a direction X perpendicular to the direction of belt advancement Y, e.g. the crossweb direction. As the belt 106 moves into engagement with the first guides 108 the rigid engagement between the belt 106 and the first guide 108 may result in a change in the belt tension, as the first guide 108 is attached to the support structure 105 by the substantially rigid fastener 107 so that its position is substantially fixed and hence the first guide 108 may not move, e.g. have its position substantially fixed, when it is engaged with a portion of the belt 106. This may change the belt tension. In this example, such a change in the belt tension may be accommodated for by movement of the second guide 110. For example, any movement resulting from the engagement between the first guide 108 and the belt 106 may be transferred across the belt (e.g. in the crossweb direction X) and to the second guide 110 which, being in a movable position, may move to accommodate, or “absorb”, the transmitted movement by moving, or displacing, in the crossweb direction X. In an example where the second guide 110 was not present, or were not in a movable position relative to the print station 100, any transferred movement, or change in tension, may not be able to be “relieved” and this may in turn result in a registration error. In other words, the movable and fixed guides may align or maintain the belt's position in the crossweb direction and also maintain the belt under traversal, e.g. in the crossweb direction, tension. For example, the movable and fixed guides may avoid or reduce (e.g. reduce the intensity of) any crossweb perturbations that may result from local deformations, whilst aligning the belt prior to advancing under a print bar.

In one example, the guide may comprise a roller to, passively or actively, advance the belt. In one example, the guide may comprise a formation, for example a groove to receive a part of the belt. In one example, the guide may comprise a protrusion to engage a part of the belt.

In one example, a printing apparatus comprises multiple print stations, and each print station may comprise a conveyance module 100. In this example, the guides 108, 110 on each print station may align the belt's position relative to each print station prior to printing fluid being deposited by the print bar at each print station.

Therefore, alignment of a sheet attached to the belt (e.g. by a vacuum) may occur print to the deposition of printing fluid at each print zone.

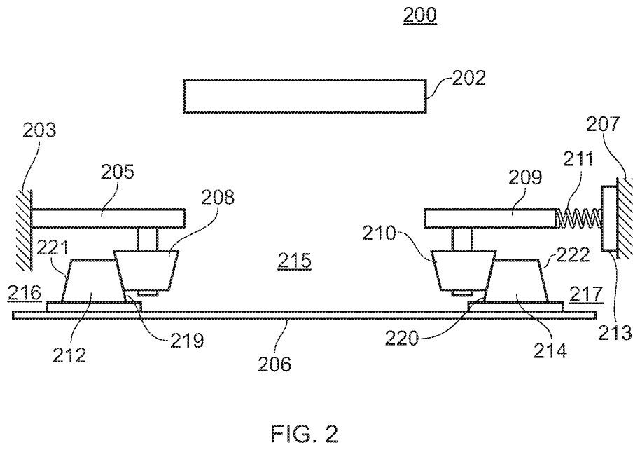

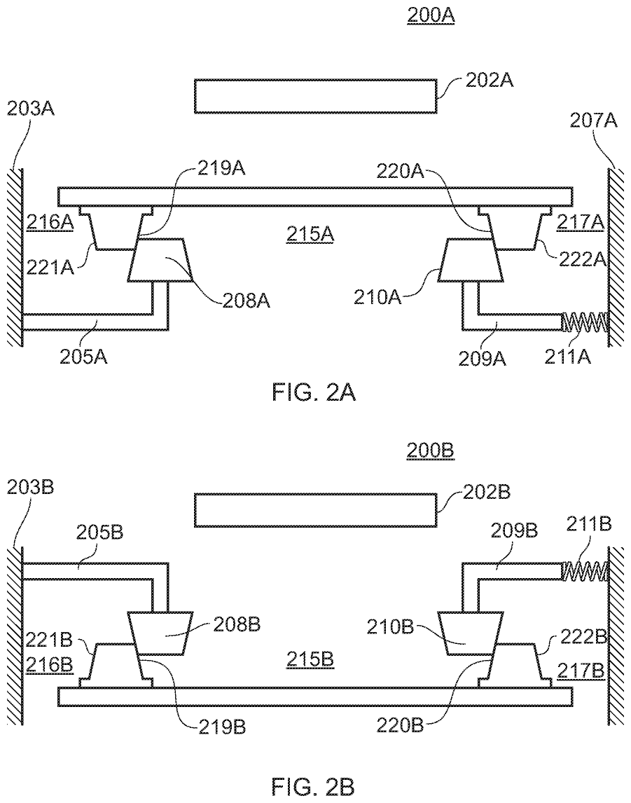

FIGS. 2, 2A and 2B each show an example conveyance module 200, 200a, 200b. The conveyance modules 200, 200a, 200b may be part of a print apparatus, for example a print apparatus comprising a plurality of print stations. For example, the conveyance modules 200, 200a, 200b may be part of a continuous print process (e.g. a print apparatus comprising a belt path on which a substrate may move continuously through a plurality of print stations).

Referring to the example of FIG. 2, a conveyance module 200 comprises a support structure 203, 207 to support a belt 206 and to permit advance of the belt 206 toward a print station (in the example of FIG. 2 represented by the print bar 202). In this example, a print bar 202 is positioned to deposit printing fluid onto a belt 206, the belt being advanced by the conveyance module 200. In this example, the print bar 202 is not part of the conveyance module although in other examples it may be. Print bar 202 is to deliver printing fluid onto a belt 206. The conveyance module 200 comprises a pair of guides, which may be first and second rollers 208, 210. Each roller 208, 210 is to engage a portion of the belt 206. In the example shown in FIG. 2, the belt 206 comprises a pair of ribs, 212, 214 attached to the belt, e.g., by welding. In this example, each roller 208, 210 is to engage a respective rib 212, 214 of the belt 206.

The first roller 208 is held in a substantially fixed position relative to the support structure 203, 207, and therefore relative to the conveyance module 200 and a second roller 210 is held in a movable position relative to the support structure 203, 207, and therefore relative to the conveyance module 200. In this example, the first roller 208 is attached to a first portion 203 of the supports structure by a substantially rigid fastener 205, which is held in a substantially fixed position relative to the print station 200. In one example, the substantially rigid fastener 205 is attached to the support structure 203 of the print station 200, for example connected to (e.g. via a fastener such as bolts or screws etc.), welded to, adhered to etc. This may be to hold the substantially rigid fastener 205 in a substantially fixed position, but the position may be adjustable (e.g. via unloosening of any connecting bolts/screws etc.) In one example, the second roller 210 may be attached to a second portion 207 of the support structure by a resiliently deformable element 211. In this example, the second roller 210 may be attached to a substantially rigid arm 209 which is attached to the support structure 207 (or a part thereof) by the resiliently deformable element 211. In one example, the second roller 210 may be directly attached to the support structure or a part thereof by the resiliently deformable element 211 (for example, in some examples, the substantially rigid arm 209 may be omitted). In the example of FIG. 2, the resiliently deformable element 211 is attached to the support structure 207 via a block 213. In some example, however, the block 213 may be omitted and the resiliently deformable element 209 may be directly attached to the support structure 207.

In one example the resiliently deformable element 211 comprises a biasing element. In one example, the resiliently deformable element comprises an elastic element. In one example, the resiliently deformable element comprises a spring. The second roller 210 may therefore be attached to the support structure 207 via a spring.

The resiliently deformable element 211 may be to bias the second roller 210 into contact with a portion of the belt 206, e.g. a rib 214 of the belt, to engage the belt 206 (or rib 214 thereof). The resiliently deformable element 211 may therefore be to bias the second roller 210 into contact with the belt 206 (e.g. a rib 214 thereof), while avoiding large friction forces. In one example, the resiliently deformable element 211 may be to bias the second roller 210 in a direction opposite to the first roller 208.

In one example, the resiliently deformable element 211 is a spring. In this example, the spring constant may be 3 N/mm. In one example, the length of the spring may be 100 mm and the length of the block 213 may be 35 mm. In one example, the spring may be selected so that it has a spring constant to withstand any friction caused by the forces acting on the belt in use. For example, the spring may be selected to withstand a force of 200 N (e.g. a minimum force of 200 N) acting on the belt in the crossweb direction. In one example, the spring may be selected to withstand a force of 200N acting on a belt 64 inches in width, and under a vacuum level of 1200 Pa (e.g. a vacuum force holding a substrate to the belt) with a static friction coefficient of 2.1.

In the example shown in FIG. 2, the belt 206 comprises first and second ribs 212, 214. The ribs may be welded ribs. Accordingly, in one example the belt 206 may comprise first and second welds 212, 214. In one example, the ribs, or welds, 212, 214 may be continuous, e.g. they may extend continuously along the entire length of the belt 206. In one example, each rib 212, 214 may be welded to the belt 206, for example welded to the entire length of the belt 206. In one example, they may be welded to the belt parallel to a belt-advance direction (e.g. the direction of belt movements when the belt 206 is in use in a printing apparatus during a print operation). In such an example, each rib 212, 214 may be machined, or milled, to achieve a predetermined straightness with respect to the belt-advance direction. For example, the ribs 212, 214 may be machined, or milled, to be substantially parallel to the belt-advance direction. In one example, the ribs 212, 214 may be welded, machined and milled, to be substantially parallel to one another and, in one example also substantially parallel to the belt-advance direction.

A substrate may be supported at or on the belt 206. For example, a substrate such as a sheet may be held to the belt 206, for example via a vacuum. Therefore, as the belt 206 advances toward and under the print bar 202 (e.g. advanced by the conveyance module 200), the sheet held to the belt may also advance toward and under the print bar 202.

As shown in the example depicted in FIG. 2, each rib 212, 214 is attached to the side of the belt 206 facing the print bar 202, e.g. by welding. This may be referred to as the print bar side of the belt 206. In use, this side of the belt 206 may face upwards toward the print bar 202 as the print bar 202 is to deposit printing fluid downward, e.g. using the force of gravity, toward the belt (e.g. onto a sheet supported thereon).

In the example shown in FIG. 2A, each rib 212a, 214a is attached to the other side (e.g. an opposite side) of the belt to that shown in the example of FIG. 2, e.g. welded to the side of the belt 206a that, in use, does not face the print bar 202a. In this example, the two guides 208a, 210a, rather than facing the print bar side of the belt 206a would face the side of the belt that does not face the print bar 202a in use.

In one example, one of the two ribs may be attached to the side of the belt that faces the print bar and the other one of the two ribs may be welded to the other side of the belt, e.g. the side of the belt that, in use, does not face the print bar.

The pair of ribs 212, 214 define an area 215, or an inner portion of the belt 206, between the ribs 212, 214. The pair of ribs 212, 214 also define two outer areas 216, 217, or outer portions of the belt 206. The area 215 in between the pair of ribs 212, 214 and is an area of the belt 216 that is bounded by the two ribs 212, 214. Each outer belt area 216, 217 is bounded by one of the ribs 212, 214 and an outer edge of the belt 206. In one example, in use, a substrate such as a sheet may be supported at the belt (e.g. attached to or held against the belt such as via a vacuum) in the area 215 between the two ribs 212, 214, and therefore a substrate may be supported at the belt in the inner belt area 215. The pair of ribs 212, 214 therefore each have a first side 219, 210 and a second side 221, 222. The first side 219, 220 of each rib is a side of the rib 212, 214 that faces toward the centre of the belt. The first sides 219, 220 may therefore be inward-facing sides. The second side 221, 222 of each rib is a side of the rib 212, 214 that faces away from the centre of the belt. The second sides 221, 222 may therefore be outward-facing sides. The pair of ribs 212, 214 may have trapezoidal cross sections, the pair of rollers 208, 209 may also have trapezoidal cross sections and the pair of ribs and the pair of rollers may be positioned in a complementary arrangement, i.e., with the bases facing opposite directions.

As shown in the examples of FIGS. 2 and 2A, each guide 208, 210, 208a, 210a is to engage the first side 219, 220, 219a, 220a of a respective rib 212, 214, 212a, 214a. Therefore, in the example of FIG. 2, each guide 208, 210, 208a, 210a is to engage the sides 219, 220, 219a, 220a of the ribs, 212, 214, 212a, 214a that faces toward the centre of the belt 206, 206a. In these examples, the guides may be said to engage an ‘inner side’ of the belt, or ‘inner sides’, or ‘inward-facing sides’ of the ribs.

In the example shown in FIG. 2B, each guide 208b, 210b, is to engage the second side 221b, 222b, of a respective rib 212b, 214b. Therefore, in the example of FIG. 2B, each guide 208b, 210b, is to engage the sides 221b, 222b, of the ribs 212b, 214b, that face away from the centre of the belt 206b. In these examples, the guides may be said to engage an ‘outer side’ of the belt, or ‘outer sides’, or ‘outer-facing sides’, of the ribs.

Although the examples of FIGS. 2A and 2B do not show the block 213, in some example, the resiliently deformable elements 211a, 211b of the examples of FIGS. 2A and 2B may be attached to the support structure 207a, 207b by a block.

In one example, a first guide may engage the first side of a first rib (which may be the side facing toward the centre of the belt) and a second guide may engage the second side of a second rib (which may be the side facing away from the centre of the belt).

In one example, a printing apparatus comprises multiple print stations, and each print station may comprise a conveyance module, such as conveyance module 200, 200a, or 200b. In this example, the guides on each print station, may align the belt's position relative to the print station prior to printing fluid being deposited by the print bar at each print station. Therefore, alignment of a sheet attached to the belt (e.g. by a vacuum) may occur print to each deposition of printing fluid at a print zone.

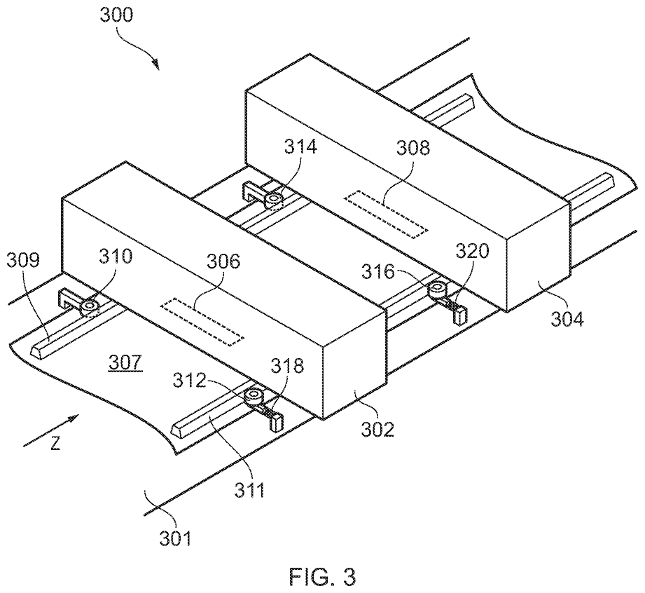

FIG. 3 shows an example print apparatus 300. The print apparatus 300 comprises a plurality of printing fluid dispensing units, first and second printing fluid dispensing units 302 and 304, respectively. Each one of the first and second printing fluid dispensing units 302, 304 is to dispense printing fluid towards a belt 307. Each one of the first and second printing fluid dispensing units 302, 304 comprises a print bar 306, 308, and each print bar 306, 308 is to dispense printing fluid toward a belt 307.

The print apparatus 300 may be used in a continuous printing process, for example a ‘multi-pass’ print process. In such an example process, a substrate such as a sheet may be continuously advanced, e.g. by the belt 307 as the substrate may be held to the belt via vacuum, through a plurality of printing fluid dispensing units 302, 304. At each printing fluid dispensing unit 302, 304 printing fluid may be dispensed toward the belt 307 and onto the substrate (e.g. by the print bars 306, 308). Each printing fluid dispensing unit 302, 304 may dispense printing fluid of a different colour toward the belt 307 as to produce a colour image on the substrate.

In one example, the print apparatus 300 may align the position of the belt 307 relative to each printing fluid dispensing unit 302, 304 prior to the belt 307 advancing through each printing fluid dispensing unit 302, 304 and under each print bar 306, 308. For example, as the belt 307 advances toward each printing fluid dispensing unit 302, 304, the position of the belt 307 may be aligned relative to the printing fluid dispending units 302, 304 and therefore relative to the print bars 306, 308. For example, the position of the belt 307 may be aligned, or fixed, in the crossweb direction. This may reduce the crossweb error in a printing process as the belt (and therefore a substrate attached thereto) may be aligned relative to the printing fluid dispensing units 302, 304 prior to advancing underneath each print bar 306, 308.

The printing apparatus 300 of this example comprises a conveyor 301 to advance the belt 307 on a belt path Z via the first and second printing fluid dispensing units 302, 304. The conveyor 301 comprises a first pair of rollers and a second pair of rollers. In this example, the first pair of rollers comprises first and second rollers, 310, 312, respectively and the second pair of rollers comprises third and fourth rollers, 314, 316, respectively. Each roller 310, 312, 314, 316 is to engage a portion of the belt 307 to direct the belt 307 toward and/or through one of the printing fluid dispensing units. The first and second rollers 310, 312 in this example are to engage a portion of the belt 307 prior to the belt 307 advancing toward the first printing fluid dispensing unit 302 and the third and fourth rollers 314, 416 are to engage a portion of the belt 307 prior to the belt 307 advancing toward the second printing fluid dispensing unit 304. Each roller 310, 312, 314, 316 may be to, passively or actively, advance the belt 307 through a printing station.

In the example of FIG. 3, the print bars 306 and 308 are each part of a separate printing fluid dispensing unit (302 and 304, respectively) and a pair of rollers is provided to align the belt 307 prior to the belt advancing toward each printing fluid dispensing unit and therefore toward each print bar. In one example, a printing fluid dispensing unit (e.g. unit 302) may comprise multiple print bars (e.g. bars 306, 308) and a pair of rollers may be provided to align the belt prior to advancing toward the printing fluid dispensing unit, and therefore toward the multiple print bars.

Each roller 310, 312, 314, 316 may comprise a rotatable roller surface to rollably engage a portion of the belt 307 as the belt 307 advances toward and past the roller 310, 312, 314, 316.

The second and fourth rollers 312, 316 in this example are resiliently biased into contact with a portion of the belt 307. For example, a resiliently biasing element 318 may be to bias the second roller 312 into contact with a portion of the belt 307 and a resiliently biasing element 320 may be to bias the fourth roller 316 into contact with a portion of the belt 307. In one example, the second and fourth rollers 312, 316 are resiliently biased in a direction perpendicular to the belt-advance direction Z, e.g. the crossweb direction. Each of the second and fourth rollers 312, 316 may therefore be movable in a direction substantially perpendicular to the belt path Z.

The resiliently biasing elements 318 or 320 may comprise a spring, e.g. a spring with sprint constant of 3 N/mm.

The first roller 310 may be fixed relative to the first print unit 302 and the third roller 314 may be fixed relative to the second print unit 304. For example, the first roller 310 may be held in a substantially fixed position relative to the first print unit 302 and the third roller 314 may be held in a substantially fixed position relative to the second print unit 304.

For example, each of the first and third rollers 310, 314 may be attached to the first and second print units 302, 304, respectively, via a respective arm, being in a substantially fixed position relative to the first and second print units 302, 304 respectively. In this example, each roller may be attached to the arm via a rotatable contact thereby facilitating the roller to rotate relative to the arm.

For example, each of the first and third rollers 310, 314 may be rigidly attached to the conveyor 301 to align the position of the belt 307 in a direction substantially perpendicular to the belt path Z (e.g. the crossweb direction) as the belt 307 advances toward the first and second printing fluid dispensing units 302, 304, respectively.

The first and third rollers 310, 314 may fixed to the conveyor 301. For example, they may be removably fixed to the conveyor 301 in that they may re-positionable. For example, the first and third rollers 310, 314 may be fixed to the conveyor 301 by an attachment mechanism, such as screws or bolts, which may be loosened allowing for the rollers to be repositioned at another location in the print apparatus 300, relative to the conveyor 301 and to the printing fluid dispensing units 302, 304.

In this example, the second roller 312 is movable relative to the print unit 302 and the fourth roller 316 is movable relative to the print unit 304. For example, the second roller 312 may be held in a movable position relative to the print unit 302 and the fourth roller 316 may be held in a movable position relative to the print unit 304.

Although in the example of FIG. 3, the second and fourth rollers 312 and 316 are shown attached to the conveyor 301, in one example, each of the second and fourth rollers 312, 316 may be attached to the first and second print units 302, 304, respectively, (e.g. via a respective arm, being in a movable position relative to the first and second print units 302, 304 respectively). In this example, each roller may be attached to the arm via a rotatable contact thereby facilitating the roller to rotate relative to the arm. The second and fourth rollers 312, 316 may be connected, or attached, to the conveyor 301 or respective print units 302, 304, via the biasing element 318, 320, respectively. For example, the second roller 312 may be attached to the conveyor 301, or to the print unit 302, by the biasing element 318 and the fourth roller 316 may be attached to the conveyor 301, or to the print unit 304, by the biasing element 320.

Each biasing element 318, 320 may be to bias the second and fourth rollers 312, 316, respectively into contact with a portion of the belt 307, e.g. in the crossweb direction.

In the example of FIG. 3, the belt 307 comprises a pair of guides, e.g. welds 309, 311. In one example, each weld 309, 311 may be a continuous weld, e.g. each weld 309, 311 may extend along the belt 307 for substantially the length of the belt 307. Each weld 309, 311 may be parallel to each other and/or the belt advance direction of the belt 307.

Accordingly, the example print apparatus 300 may reduce crossweb registration error in a print operation since the belt may be aligned prior to the belt travelling past the printing fluid dispensing units. For example, prior to traveling under each printing fluid dispensing unit, engagement between the roller and a belt weld may align the belt, e.g. in the crossweb direction, relative to the print units. In one example, aligning the belt may comprise fixing the belt's position relative to the print unit, e.g. in the crossweb direction.

During such an alignment procedure, the weld of the belt, in one example, may rigidly engage one of the rollers. For example, as the belt 307 travels toward the first print unit 302, the weld 309 may engage the first roller 310, which is in a substantially fixed position relative to the first print unit 302. In this example, the belt weld 309 may therefore engage the first roller 310, whose position may not move relative to the first print unit 302. However, such rigid engagement may, in some examples, result in a change of the tension of the belt 307. This may be accommodated for by the second roller 312 which, being in a movable position relative to the print unit 302, may movably engage the second weld 311 of the belt 307. In this way, any increased tension in the belt 307 may be transferred to the second roller 312 and away from the belt, as the second roller 312 is to move to absorb or transfer any such tension. The movable second roller 312 may therefore be to move to absorb any increased tension in the belt 307.

The welds 309, 311 may engage the respective first and second rollers 310, 312 at substantially the same time. In one example, one of the first and second rollers 310, 312 may be disposed at the printing fluid dispensing unit 302 such that the welds 309, 311 may engage the first and second rollers 310, 312, respectively, at different times as the belt 307 advances toward the first printing fluid dispensing unit 302.

The welds 309, 311 may, in one example, be welded ribs.

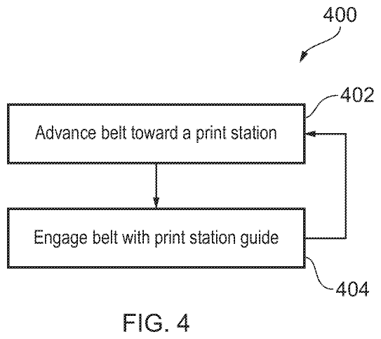

FIG. 4 is an example method 400, which may be a method for guiding or advancing a belt through a print apparatus. Method 400 may be a method for guiding or advancing a substrate or a sheet (e.g. via a belt) through a print apparatus. Method 400 may be performed during, or as part of, a print operation.

The method 400 comprises, at block 402, advancing a belt toward a print station (e.g. through a print station). At block 404, the method 400 comprises, as the belt advances toward the print station, engaging the belt with a print station guide. For example, at block 404, the method 400 may comprise, engaging the belt with a first print station guide that is held in a substantially fixed position relative to the print station and/or a second print station guide that is held in a movable position relative to the print station. Engagement of the belt and the first print station guide may fix the belt's position relative to the print station. Any tension produced as a result of engagement between the belt and the first print station guide may be transferred to and absorbed by the second, movable, print station guide. As indicated by the looping arrow between blocks 404 and 402 the method 400 may be repeated for each print station.

Engaging the belt and a print station guide (e.g. the first print station guide) according to the method 400 prior to each print instance, e.g. prior to each instance of printing fluid being deposited onto a substrate attached to the belt, may reduce, or minimise, the crossweb error as the alignment of the belt (and therefore of any substrate attached thereto) may be adjusted prior to the belt advancing under a print bar or printing fluid unit of the print station.

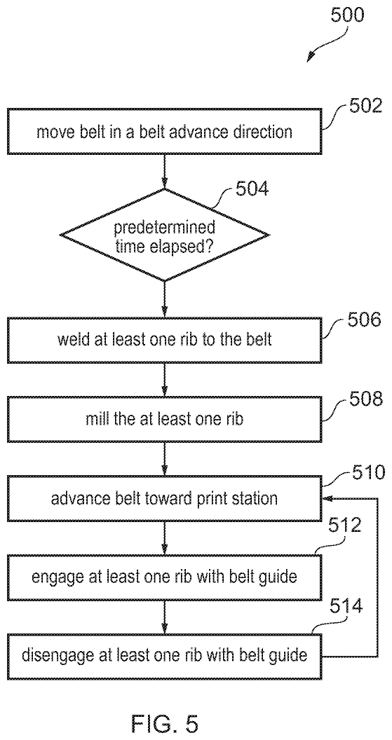

FIG. 5 is an example method 500, which may be a method for guiding or advancing a belt through a print apparatus. Method 500 may be a method for guiding or advancing a substrate or a sheet (e.g. via a belt) through a print apparatus. Method 500 may be a method of welding a rib to a belt, for example prior to a print operation. Method 500 may be performed prior, during, or as part of, a print operation.

The method 500 comprises, at block 502, moving a belt in a belt advance direction. If it is determined, at block 504, that a predetermined time has elapsed then at block 506, a rib is welded to the belt.

In one example, block 502 may comprise welding a pair of ribs to the belt. In one example, block 502 may comprise welding a pair of ribs to the belt such that the ribs extend substantially the length of the belt. In one example, block 502 may comprise welding a pair of ribs to the belt such they are substantially parallel to each other. In one example, block 502 may comprise welding a pair of ribs to the belt such they are substantially parallel to the belt advance direction.

At block 508, the method 500 comprises milling the rib (welded to the belt at block 506).

In one example, at block 502 a pair of ribs may be welded to the belt as above. In this example, block 508 may comprise milling both of the welded ribs.

In one example the ribs may be welded such that they achieve a predetermined straightness.

At block 510, the method 500 comprises advancing a belt toward a print station. At block 512, the method 500 comprises engaging one rib of the belt with a print station guide as the belt advances toward the print station. For example, at block 512 the method 500 may comprise engaging the belt with a first print station guide and a second print station guide. The first print station guide may be held in a substantially fixed position relative to the print station and the second print station guide may be held in a movable position relative to the print station. Engagement of the rib and the first, substantially fixed, print station guide may fix the belt's position relative to the print station. At block 514, the method 500 comprises disengaging the rib with the print station guide. As indicated by the looping arrow between blocks 514 and 510, these blocks of the method 500 may be repeated for each print station.

Blocks 510-514 of the method 500 may therefore be a part of a printing process. Accordingly, blocks 502-508 of the method 500 may be performed prior to a printing process, or printing operation. These blocks may prepare the belt for being used in a printing operation. Blocks 510-514 may subsequently be performed during an operation in which printing fluid is to be deposited into a substrate held by the belt by a plurality of print stations (as indicated by the looping arrow). At each printing station the position of the belt may be aligned to reduce, or minimise, the crossweb error.

The rib may be milled, or machined, at block 508, in the belt advance direction.

In one example, at block 506 two ribs may be welded to the belt, e.g. in the belt-advance direction. For example, two ribs may be welded to the belt such that the distance between the ribs is substantially constant along the length of the belt (along the belt-advance direction). At block 508 each rib may be machined or milled, e.g. in the belt-advance direction, to ensure a predetermined straightness of the ribs, and such that the distance between the ribs is well-controlled (e.g. substantially constant) along the length of the belt.

The print stations 100 and 200 of FIGS. 1 and 2, respectively, and the print apparatus 300 of FIG. 3 may be to perform the method 400 of FIG. 4 or the method 500 of FIG. 5.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A conveyance module to advance a belt toward a print bar, the conveyance module comprising:
a support structure to support a belt and to permit advance of the belt in a belt-advance direction toward a print bar; and
a pair of guides, wherein each guide is attached to the support structure, and wherein each guide is to engage a portion of a belt;
wherein a first guide in the pair is attached to the support structure by a substantially rigid fastener to hold the first guide in a substantially fixed position relative to the support structure, and wherein a second guide in the pair is attached to the support structure by a resiliently deformable element to hold the second guide in a movable position relative to the support structure.

2. A conveyance module as claimed in claim 1 wherein the position of the second guide is movable in a direction substantially perpendicular to the belt-advance direction.

3. A conveyance module as claimed in claim 1 wherein the resiliently deformable element is to bias the second guide into contact with at least a portion of a belt to engage the belt.

4. A conveyance module as claimed in claim 1 wherein the first and second guides are rollers.

5. A conveyance module as claimed in claim 1 wherein the resiliently deformable element comprises a spring.

6. A conveyance module as claimed in claim 5 wherein the spring constant of the spring is 3 N/mm.

7. A print apparatus comprising:
a first printing fluid dispensing unit to dispense printing fluid toward a belt;
a second printing fluid dispensing unit to dispense printing fluid toward a belt; and
a conveyor to advance a belt on a belt path via the first and second printing fluid dispensing units; wherein the conveyor comprises:
first and second rollers to engage a portion of the belt prior to the belt advancing toward the first printing fluid dispensing unit; and
third and fourth rollers to engage a portion of the belt prior to the belt advancing toward the second printing fluid dispensing unit; and
wherein the second and fourth rollers are resiliently biased into contact with a portion of the belt.

8. A print apparatus as claimed in claim 7 wherein each of the second and fourth rollers are resiliently biased into contact with a portion of the belt via a spring.

9. A print apparatus as claimed in claim 7 wherein each of the second and fourth rollers are movable in a direction substantially perpendicular to the belt path.

10. A print apparatus as claimed in claim 7 wherein the first roller is rigidly attached to the conveyor to align the position of the belt in a direction substantially perpendicular to the belt path as the belt advances toward the first printing fluid dispensing unit, and wherein the second roller is rigidly attached to the conveyor to align the position of the belt in a direction substantially perpendicular to the belt path as the belt advances toward the second printing fluid dispensing unit.

11. A method comprising:
advancing a belt toward a plurality of print stations, each print station comprising a first print station guide held in a substantially fixed position relative to the print station and a second print station guide held in a movable position relative to the print station;
wherein, as the belt advances toward each print station, the belt engages the first print station guide to align the belt's position relative to the first print station.

12. A method as claimed in claim 11 further comprising, as the belt exits from each print station, disengaging the belt from the first print station guide.

13. A method as claimed in claim 11 further comprising:
welding a rib to a belt, wherein, as the belt advances toward each print station, the welded rib of the belt engages the first print station guide to align the belt's position relative to the print station.

14. A method as claimed in claim 13 further comprising:
moving the belt in a belt advance direction for a predetermined time period; and, after the predetermined time period has elapsed, welding the rib to the belt.

15. A method as claimed in claim 13 further comprising:
milling one side of the rib to straighten the side of the rib.
